(19) United States
(12) Patent Application Publication
(10) Pub. No.: US 2007/0025330 A1
(43) Pub. Date: Feb. 1, 2007

(54) Method for remote playing of computer audio content with PDA-assisted navigation

(76) Inventor: Kirill Levin, New York, NY (US)

Correspondence Address: KIRILL LEVIN, 260 W52 STREET #21A, NEW YORK, NY, 10019, US

(21) Appl. No.: 11/160,917

(22) Filed: Jul. 15, 2005

(51) Int. Cl. G06F 17/00; H04L 12/66

(52) U.S. Cl. 370/352; 700/94

(57) ABSTRACT

Audio signal produced by a computer while playing computer audio content (such as audio files, real-time streaming audio, internet radio stations, etc.) is transmitted to remote location in the home and reproduced by a home audio system. The method is provided for remote navigation through such audio content and for playback control. Personal Digital Assistant (PDA) is used as a user interface device at the preferred user location. Standard infrared (IR) port of the PDA is used for the command transmission. Alternatively, a standard IR remote control device can be used for a limited interface. A specialized adapter placed at the user location is receiving command signal from PDA device and retransmitting it to the computer, thus allowing user to be located at sufficient distance from the computer.

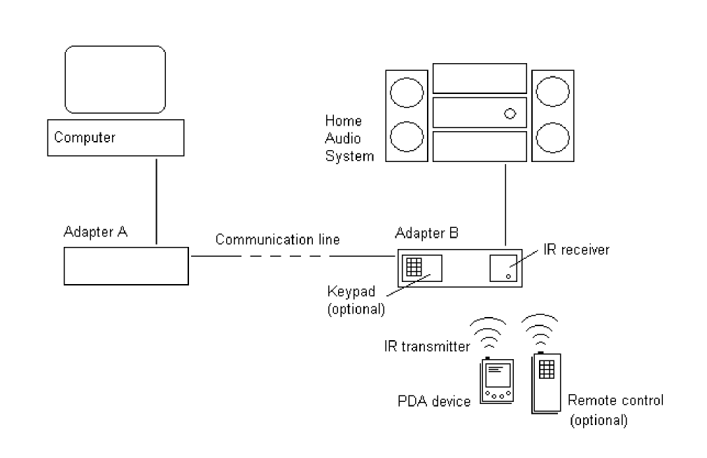

### FIELD OF THE INVENTION

This invention relates generally to the field of home entertainment and, in particular, to a playback of computer audio content using home audio system.

### DESCRIPTION OF THE RELATED ART

Usage of digital formats for music storage has become enormously popular in recent years. Typically, the home computer is used for downloading, storage, selection and playback of the music files. This restricts the location of the user while listening, and especially, when selecting the music files.

One way to improve user's mobility inside a home is to provide a connection between the computer and the home audio system (for example: Apple AirPort; Sound Blaster ® Wireless Music, U.S. Pat. No. 5,946,604 to Bailey; etc). Then, as usual, the music files could be downloaded, stored and reproduced by the computer while user can listen and control the playback from the preferred location.

In order to select audio content, a user interface should be provided at the user's location. Using this interface, the user should be able to browse through the audio content available, select the items for playback and control the playback. Then, according to the user's actions, the command signal is generated and sent back to the computer.

While transmitting the command signal back to the computer presents no technical problem, the challenge is to provide user with the information required for navigation and selection of the available audio content. There exist several implementations of such interface involving LCD-enabled remote control (Sound Blaster ® Wireless Music), television screen (Linksys Wireless-B Media Adapter), etc. However, the hardware required by these methods, can be sophisticated and costly.

Alternatively, there exist solutions that allow to use popular PDA devices for the remote control of home electronics or computer (for example: OmniRemote) utilizing PDA's standard IR port or embedded BlueTooth capability. However, this technique requires computer to be located in direct line of sight (IR) or in close proximity (BlueTooth) of the controlling PDA device, limiting user's location to one room.

Therefore, there is a need for economical method of remote audio content browsing, playlist selection and playback control.

What is claimed is:

1. The method for digital audio content playback and control and communication system thereof comprising of:
a. personal computer playing digital audio content including but not limited to digital music files and internet radio stations
b. audio connection transmitting signal from the personal computer to the reproducing device at the user location
c. control connection transmitting user commands from the user location to the personal computer
d. adaptor at the user location being part of the control connection
e. means of PDA interface including but not limited to infrared port or PDA cradle being part of said adaptor
f. PDA device used interfacing with adaptor through said means.

2. The method, as claimed in claim 1, wherein:
a. PDA device memory contains a catalog of digital audio content available to the personal computer
b. said catalog being periodically synchronized with the personal computer
c. PDA software allowing user to select audio content from the catalog for immediate of future playback
d. PDA software allowing user to control playback in real time including but not limited to playing, stopping, pausing, rewind, fast forward and volume change
e. PDA software transmitting user command user commands in respect to the playback to the adaptor using the means claimed in claim 1.

3. The method, as claimed in claim 1, wherein:
a. personal computer software running on personal computer as claimed in 1a and controlling digital audio content playback
b. said computer software receiving user commands as claimed in 2e via control connection as claimed in claim 1
c. said computer software executing received commands with respect to the audio content playback.
